(19) United States
(12) Patent Application Publication
(10) Pub. No.: US 2006/0277020 A1
(43) Pub. Date: Dec. 7, 2006

(54) A reconfigurable system for verification of electronic circuits using high-speed serial links to connect asymmetrical evaluation and canvassing instruction processors

(75) Inventors: Subbu Ganesan, Saratoga, CA (US); Leonid Alexander Broukhis, Fremont, CA (US); Ramesh Narayanaswamy, Palo Alto, CA (US); Ian Michael Nixon, Sunnyvale, CA (US); Thomas Hanni Spencer, Sunnyvale, CA (US)

Correspondence Address: PATENTRY, P.O. BOX 151616, SAN RAFAEL, CA, 94915-1616, US

(73) Assignee: THARAS SYSTEMS, Santa Clara, CA (US)

(21) Appl. No.: 11/307,206

(22) Filed: Jan. 26, 2006

Related U.S. Application Data
(63) Continuation-in-part of application No. 11/307,198, filed on Jan. 26, 2006.
(60) Provisional application No. 60/595,057, filed on Jun. 2, 2005.

(51) Int. Cl. G06F 17/50

(52) U.S. Cl. 703/14; 703/16; 703/26

(57) ABSTRACT

A reconfigurable scalable system for verifying electronic circuit designs in anticipation of fabrication by compiling a hardware description to instructions for canvassing processors and instructions for circuit evaluation processors which are scalably interconnected by reconfigurable high-speed serial links to provide simulation and emulation, having deterministically scheduled transfer of circuit signal values among the large number of circuit evaluation processors.

### CROSS-REFERENCE TO RELATED APPLICATIONS

The present application claims the benefit of priority under 35 USC .sctn. 119(e) from U.S. provisional patent application 60/595,057 filing date Jun. 2, 2005 first named inventor Ganesan, titled: “Massively parallel platform for accelerated verification of hardware and software.”

The present application is a continuation in part of pending U.S. utility patent application Ser. No. 11/307198 filing date Jan. 26, 2006 first named inventor Ganesan, titled “A scalable system for simulation and emulation of electronic circuits using asymmetrical evaluation and canvassing instruction processors”.

### BACKGROUND OF THE INVENTION

1. Field of the Invention

The present invention relates to the electronic design of integrated circuits, and more specifically to a method for the functional verification of a target integrated circuit design.

2. Related Art

Functional verification is one of the steps in the design of integrated circuits. Functional verification generally refers to determining whether a design representing an integrated circuit performs a function it is designed for. The inventors have previously disclosed functional verification systems (U.S. Pat. No. 6,691,287, 6,629,297, 6,629,296, 6,625,786, 6,480,988, 6,470,480, and 6,138,266) in which a target design is partitioned into many combinational logic blocks connected by sequential elements. The state tables corresponding to the logic blocks are evaluated and stored in multiple random access storage devices (RASDs). Such an approach may have several disadvantages. For example, some logic blocks may exceed the convenient width of typical RASDs. Some target designs may contain functional blocks such as user specific memories, or simply require many more logic blocks and internal signals than can be practically accommodated. Accordingly, the embodiments of previous patents may not be suitable in some environments.

Thus it can be appreciated that what is needed is a system to scale a hardware simulation system for electronic circuit design which limits the number of circuit signal values shared throughout the system, limits the size of the data storage and media required for circuit signal values, tolerates the occasional early or late arrival of data without faulting, allows additional hardware resources to be incrementally added easily, and limits the media requirement for a host interface. Accordingly, what is needed is a method of operating a scalable architecture for more evaluation processors than can be practically interconnected in a single chip, board, or backplane. Summary of the Invention

A system, disclosed in FIG. 1A, for verifying electronic circuit designs in anticipation of fabrication by simulation and emulation, comprising a first evaluation unit 110, a second evaluation unit 110, circuit means 120 to transfer circuit value data from the first evaluation unit and receive and store circuit value data in the second evaluation unit, a host control interface, and a compiler. An evaluation unit 110 comprises a plurality of evaluation processors 111 and one or more canvassing processors 112.

In an embodiment the circuit means 120 to transfer circuit value data may be a network using high-speed serial links as a communications medium for deterministically scheduled packets sent by a transmission circuit in the first evaluation unit and received and stored in the second evaluation unit.

### DESCRIPTION OF DRAWINGS

FIG. 1A is a block diagram of a system comprising two evaluation units.

FIG. 1B is a block diagram with further detail of an evaluation unit.

FIG. 2 is a schematic of the interconnect of a system.

FIG. 3 is a schematic of the backplane interconnect of a module.

FIG. 4 is a block diagram of an evaluation module unit.

FIG. 5A is a block diagram of the transfer circuit of a canvassing processor.

FIG. 5B is a block diagram of the read circuit of a canvassing processor.

FIG. 6 is a block diagram of units coupled by high-speed serial links.

FIG. 7 is a block diagram of three units serially coupled.

FIG. 8 is a block diagram of 8 input 8 output cascading units.

FIG. 9 is a block diagram of eight units universally coupled.

FIG. 10 is a block diagram of multi-units switchably coupled.

FIG. 11 is a block diagram of units coupled to a host computer.

### DETAILED DESCRIPTION

The present invention is a system for verifying electronic circuit designs in anticipation of fabrication by simulation and emulation. The system uses a plurality of evaluation units each made up of
a plurality of evaluation processors,
a plurality of canvassing processors,
one or more circuit signal value transfer circuits,
one or more circuit signal value reading circuits with associated transfer storage device
one or more circuit signal value storage units
one or more instruction storage units, and
busses, wires, transmission lines, or networking for transferring instructions and circuit signal values among processors, and storage units;
   a second evaluation unit;
   busses, wires, cables, transmission lines to transfer deterministically scheduled circuit signal values sent by a transfer circuit in the first evaluation unit and read and stored in the second evaluation unit; and
   a software product compiler, tangibly encoded on a computer readable storage device as instructions controlling a computer system to perform the following method: analyzing a circuit description for inherent circuit value data transfer activity among its elements, translating the circuit description to evaluation processor instructions, assigning the evaluation processor instructions to certain storage devices associated with certain evaluation processors to optimize circuit value data transfer, generating canvassing processor instructions to ensure that results from certain evaluation processors are transferred to certain other evaluation processors according to the circuit description, scheduling the execution of evaluation processor instructions and canvassing processor instructions to avoid deadlock, and transferring certain evaluation results to the host computer interface.

The evaluation processor further has data checking circuits so that execution of an evaluation processor instruction is blocked until all of the data required for the instruction is available. In an embodiment the evaluation processor is a custom application specific circuit having logic instructions corresponding to multivalue logic evaluation of three or more input logic functions. (e.g. X=x or(Z, 0, 1, X) In an alternate embodiment of the invention the evaluation processor is a commercial processor with embedded microinstructions to evaluation a sequence of two input logic functions upon inputs with three or more logic values thereby emulating a circuit having logic instructions for multivalue logic evaluation of three or more input logic functions.

The canvassing processor has transferring circuits coupled to reading circuits for avoiding overflow of the reading circuits wherein transfer is suspended until the reading circuit has available transfer storage capacity.

The present invention further comprises a method for scalably emulating the electronic circuit description, tangibly embodied as program instructions on a computer-readable medium controlling the operation of one or more processors, the method comprising the steps of
executing program instructions on a plurality of evaluation processors and on a plurality of canvassing processors resulting in the transfer of results of selected evaluation processor evaluations available to and read by selected evaluation processors to perform further evaluations; and
updating one or more circuit signal values, wherein updating in an embodiment comprises the steps of
reading a circuit signal value,
transferring a circuit signal value, and
storing a circuit signal value data in circuit signal value storage media;
   suspending the execution of evaluation instructions until data is available,
   wherein suspending comprises the steps of checking signal value transfer storage for availability of all the data necessary for executing an evaluation instruction and enabling the execution of the evaluation instruction only when the data necessary for executing the evaluation instruction is available, and
   controlling the transfer of signal values,
   wherein controlling comprises the steps of
   composing canvassing instructions to pass the results of a selected evaluation processor to those evaluation processors which require those results to execute their evaluation instructions; and
   blocking the execution of canvassing instructions,
   wherein blocking comprises the steps of checking the reading circuit data value transfer storage for unoccupied storage resource and enabling the execution of the canvassing instruction only when the reading circuit has unoccupied transfer storage resource;
compiling one or more hardware descriptions to processor instructions, wherein compiling comprises
   translating the electronic circuit description into executable evaluation instructions, and
   analyzing the circuit value transfers inherent to the electronic circuit description;
   scheduling the execution of evaluation instructions in a plurality of processors, wherein scheduling comprises
   assigning evaluation instructions among evaluation processors to optimize circuit value transfers inherent in the electronic circuit design; and
   loading the evaluation instruction storage so that a first evaluation instruction is executed after one or more second evaluation instructions on which the first evaluation instruction depends for signal value data input wherein first and second refer not to the process of execution but rather to the process of scheduling which is in reverse from outputs to inputs of the target circuit under simulation. It will be appreciated by those skilled in the art that the order of steps disclosed above may be changed or performed in parallel and the nature of the invention does not substantially depend on the sequence of steps disclosed for easier understanding of the present invention in an embodiment.

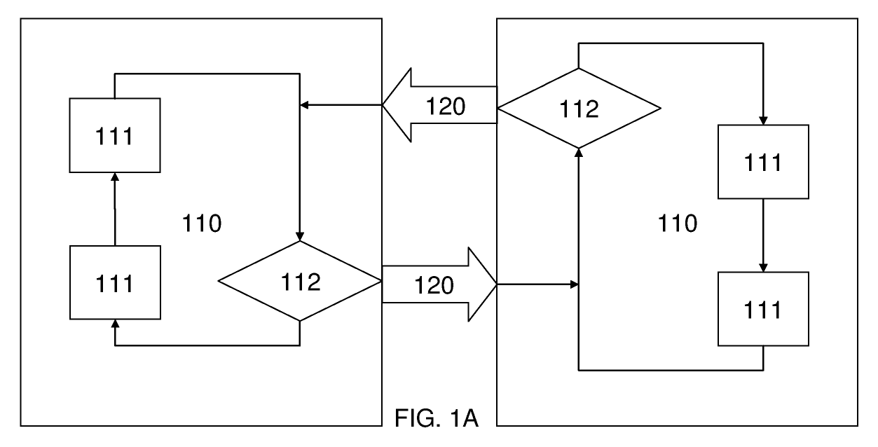

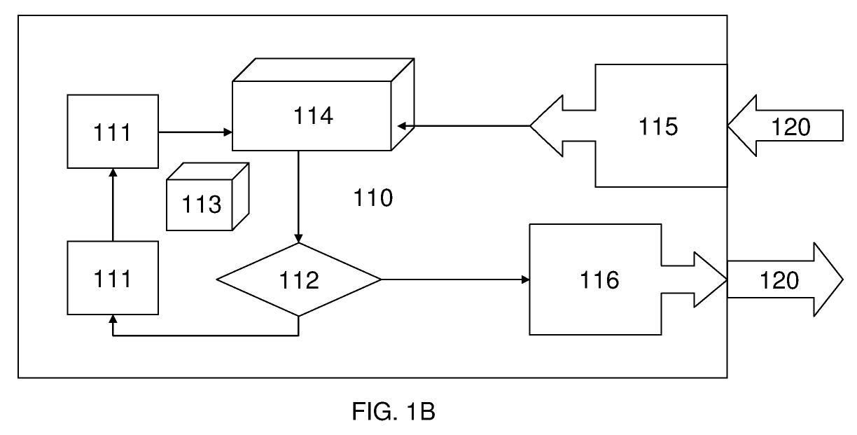

The present invention further disclosed in FIG. 1B is a system for verifying electronic circuit designs in anticipation of fabrication by simulation and emulation, comprising a first evaluation unit 110, the evaluation unit comprising: a host control interface, a plurality of evaluation processors 111, a plurality of canvassing processors 112, one or more circuit value data transfer circuits 116, one or more reading circuits 115 with associated transfer storage device, a circuit signal value storage unit 114, and instruction storage units 113.

The means for transferring an instruction or a circuit signal value among one or more processors, and one or more storage devices, include but are not limited to
wire,
printed trace,
bus,
fiberoptic cable,
transmission line, or
high-speed serial links.

Each evaluation processor is coupled to a plurality of other evaluation processors and through a canvassing processor to a medium coupled to all other evaluation processors in the system. The evaluation processor is further coupled to an instruction storage device and to a circuit value storage device. The evaluation processor is blocked from executing the instruction until all the necessary circuit values it requires as inputs are validated by a data checking circuit.

Each canvassing processor is coupled to the outputs of a plurality of evaluation processors and is coupled to certain transfer circuits of the medium. Under the control of a canvassing instruction scheduled by the compiler, it deterministically transfers a certain evaluated circuit signal value to a certain reading circuit coupled to a certain evaluation processor requiring the circuit signal value for further evaluation.

The present invention further comprises a scheduling method wherein the transfer of evaluation results are coordinated to eliminate the possibility of deadlock, a critical path reduction method wherein logic which is dependent on the results of earlier logic evaluation is grouped to optimize efficiency, a unit assigner method, and an octal meta function evaluation method, wherein operations may be performed across wider input functions.

Scheduler

The present invention further comprises a method of coordinating the evaluation of logic and transfer of logic evaluation results on a bus to eliminate the possibility of deadlock wherein results cannot reach the logic which requires input data.

The present invention further comprises a method for managing unit to unit data transfer. This takes several cycles so transfer must be scheduled within a window ahead of when data is needed in a target unit. And only so many transfers can be handled “in transit” so some logic may be held for evaluation until bandwidth is available. The method is not strictly synchronous thereby tolerating some flexibility in promptness.

Initially every transfer is assumed at its worse case of being unit to unit. By assigning an edge to intra-unit transfer it simplifies the scheduling of the bus resource and reduces the time spent in transit. An edge on the critical path is randomly chosen to be placed within a unit. If the critical path is still critical repeat, else calculate another critical path. Stop when all of the physical resources for clusters in a unit are consumed. In conventional systems there is effectively one unit and no concept of optimizing assignment across units.

The present invention further comprises a method for bus management to avoid deadlock. A window of several cycles is required to propagate evaluation output data to the subscribing evaluation inputs. So scheduling of a data receive to drive a specific cluster, means a data transmit must be done with some error margin before that and the logic evaluation that drives the bus must occur in a cluster in an advanced time.

It is not the case that transfer can occur in any order. Suppose that nodes A and B are on unit X and need to send data to unit Y. It is not necessarily the case that the data from nodes A and B can be sent from X to Y in the same cluster. For example, maybe A drives B, so A needs to be evaluated before B. If we were scheduling forward in time, this would not be an issue. However, the compiler schedules backward in time, so it needs to group signals that are to be received together before it determines exactly when they will be sent. Therefore, to prevent deadlock, the unit assigner method comprises the step of grouping signals to be communicated into packets and encoding constraints in the netlist on the order in which packets are sent to make sure that transmission ordering constraint imposed by the order in which signals are received does not conflict with other constraints on computing the order in which signals transmit.

If two units were to send too much data to each other without receiving anything, execution of both units would block and deadlock would occur. To prevent this, the compiler method comprises the steps of tracking the amount of communication in progress from each unit to each other unit. If this amount might be bigger than the transmission FIFO, the compiler method further comprises the step of avoiding scheduling receives until transmits have been scheduled. If necessary, the compiler method further comprises modifying the netlist to allow a transmission to be scheduled immediately.

The present invention comprises an evaluation unit which may be scalably interconnected to one or more other evaluation units by direct backplane connection or by optical cables and to a host interface. Two evaluation units connected by backplane comprise an evaluation module. A plurality of evaluation modules may be scalably interconnected because the compiler optimizes communication and switches circuit value data in what effectively is a deterministically scheduled packet transmission network.

An embodiment of the present invention is described as follows: A reconfigurable simulation acceleration verification center comprises a plurality of simulation acceleration appliances in a single chassis and optionally attaching to other appliances of other chassis. A method of reconfiguring the interconnect converts a plurality of simulation acceleration appliances into a single larger system.

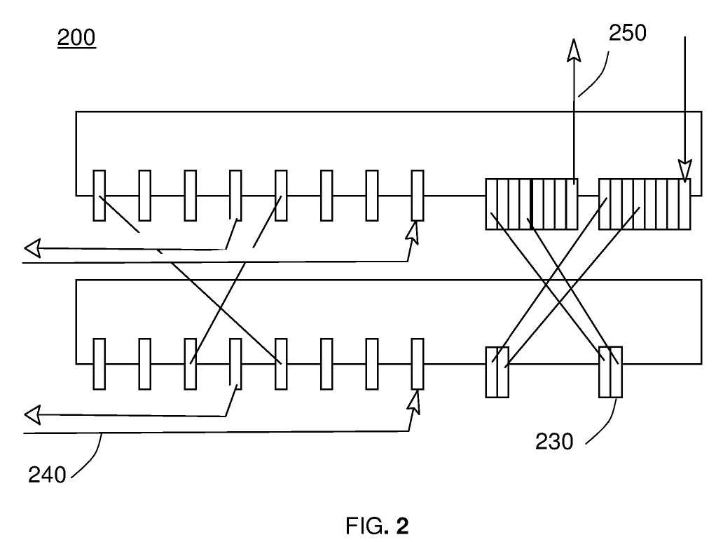

A single-user simulation acceleration verification center comprising a fiber-based interconnection topology 200 is shown in FIG. 2 attached to a plurality of evaluation module units in a chassis and optionally attaching to other evaluation module units of other chassis not shown through high speed serial links 240.

For each of the evaluation module units there may be a plurality of evaluation transmitters and receivers 210 allowing each evaluation module unit to communicate with every other evaluation module unit within its chassis as well as to an evaluation module unit in another chassis. An evaluation module unit may also have a plurality of host transmitters and host receivers 230 and connect to the first evaluation module unit in a chassis and thence to the host through high speed serial links 250.

In an embodiment each evaluation module unit may be attached by a plurality of evaluation transmitter physical links, a plurality of evaluation receiver physical links, a plurality of local evaluation receiver links, a plurality of host transmitter physical links and a plurality of host receiver physical links.

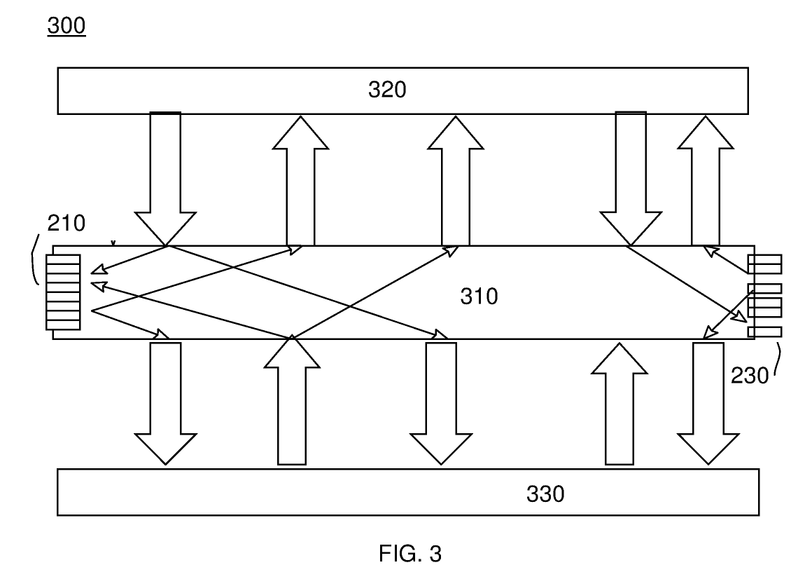

A simulation acceleration appliance 300 is shown in FIG. 3 comprising an interconnect 310 attached by high speed serial links 210 to an evaluation module unit 320 and a second evaluation module unit 330. The high speed serial links may consist of 4 types: evaluation receivers, evaluation transmitters 210 which exchange signal data between the evaluation module units, and host transmitters, and host receivers 230 which may exchange information with an attached workstation.

Evaluation Unit—An embodiment of the present invention further comprises a control processor, a plurality of octal combinational logic operation evaluators, a trace unit and a data unit attached to the interconnect network.

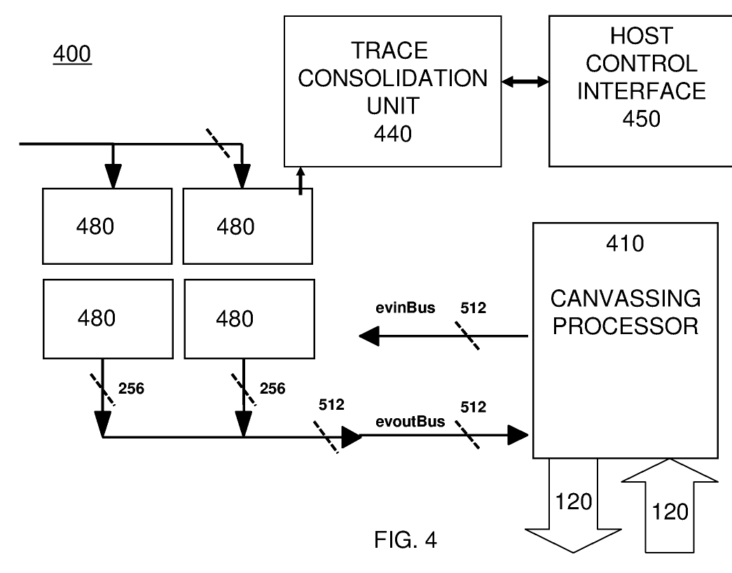

An evaluation module unit 400 shown in FIG. 4 comprising a canvassing processor 410 attached by a 512 bit bus to a plurality of micro octal simulation accelerator integrated circuits 480 attached to a trace consolidation unit 440, the evaluation module unit further comprising a host bus control 450.

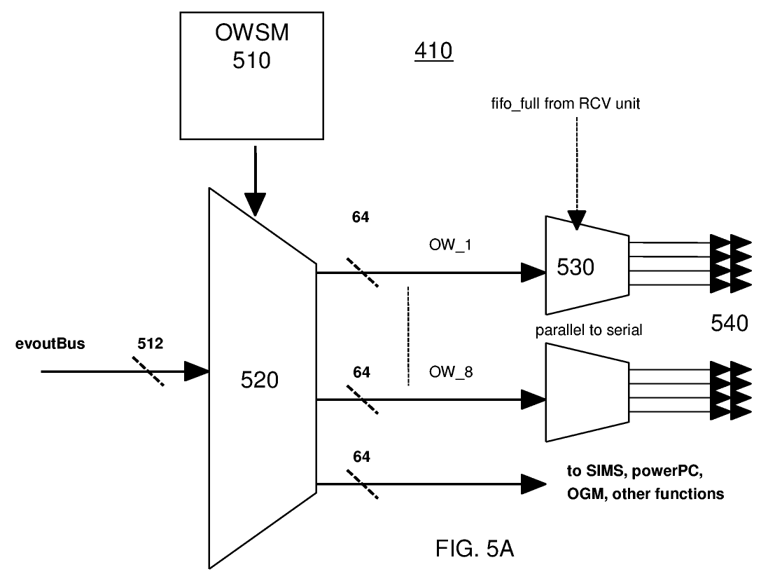

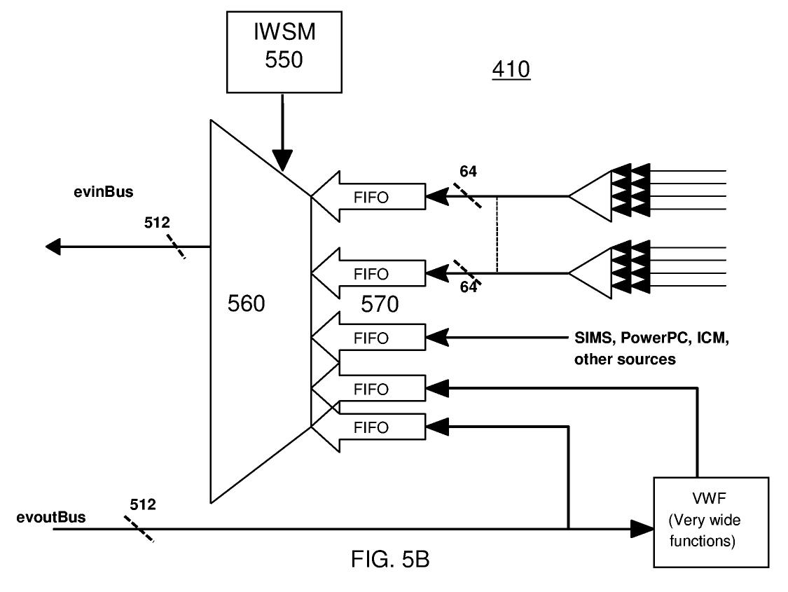

A canvassing processor 410 is shown in further detail in FIG. 5A and 5B comprising an output word select memory 510 controlling an output word select multiplexor 520 in an embodiment selecting 64 bits of the 512 bit bus, attached to a plurality, in an embodiment eight, parallel to serial converters 530 each attached to high speed serial transmitters 540, and an input word select memory 550 controlling an input word select multiplexor 560 attached to a plurality of fifo memories 570 attached variously to the evoutbus 571, a very wide function module 572, control signals 573, and a plurality, in an embodiment to eight, high speed serial link receivers 580, said input word select multiplexer 560 also driving the evinbus 562.

In an embodiment of the present invention, high speed serial links in the canvassing processor 410 are a means for transmitting between two units whereby scaling of simulation hardware accelerators as chip designs exceed the capacities of monolithic accelerator architectures is achieved beyond conventional limits.

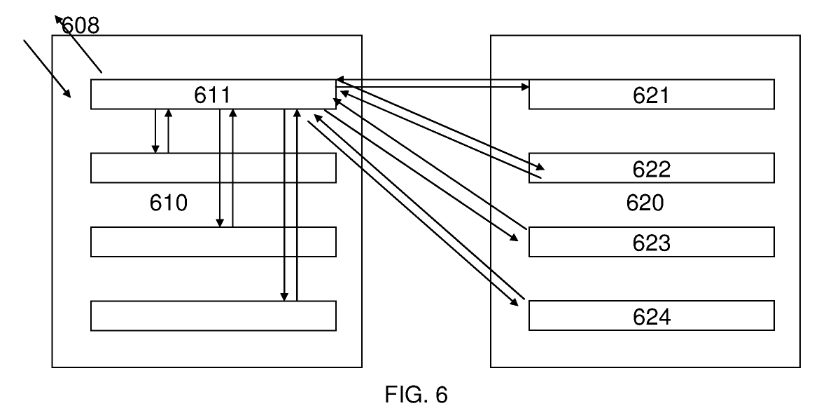

Referring now to FIG. 6 a block diagram is disclosed of units coupled by high-speed serial links. In this configuration a unit 611 can transfer evaluation results to any one of seven other units and likewise receive evaluation results from any one of seven other units. An eighth pair of transfer and receive circuits is available. Canvassing instructions executed in each unit deterministically queue circuit signal values for transfer in advance of the execution of evaluation instructions which require the values in other units. The canvassing instructions are composed and scheduled by the compiler.

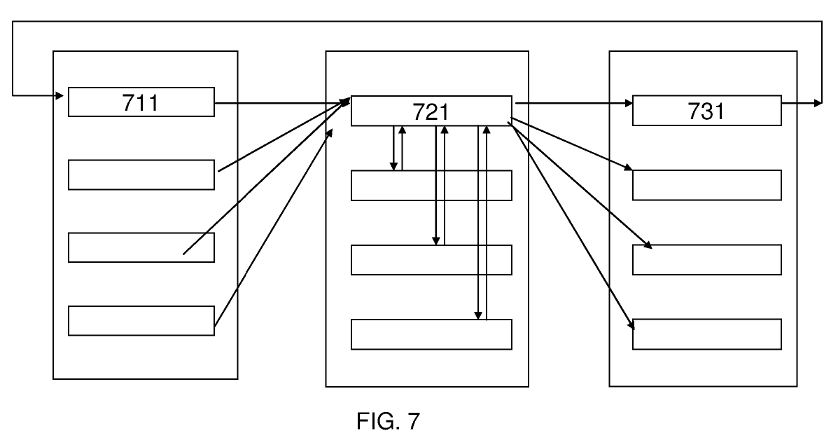

Referring now to FIG. 7 a block diagram is disclosed of three units serially coupled. A unit 721 receives a unidirectional link from one or more units on the left 711 and drives a unidirectional link to one or more units on the right 731. A deeply pipelined design may serially connect three or more units unidirectionally. The unit 721 has bidirectional pairs of links to three units within its own chassis. In an embodiment the final unit in a sequence may deliver results to a preceding unit.

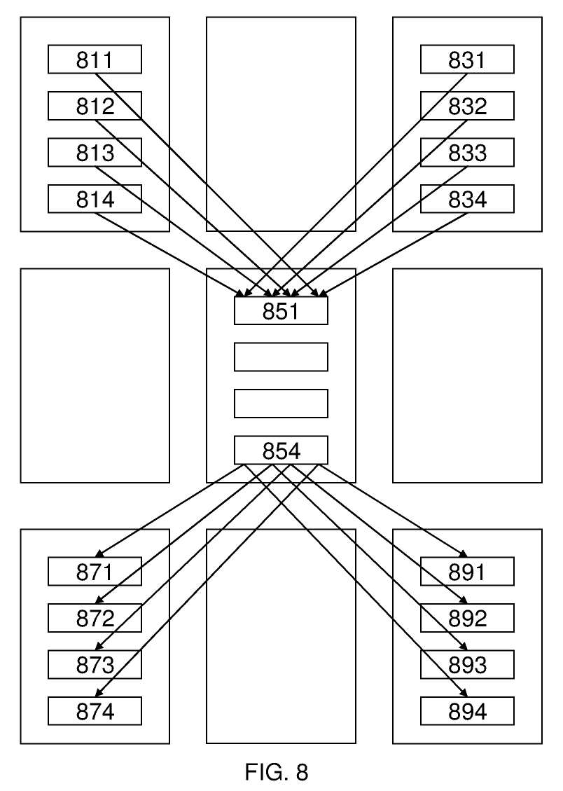

Referring now to FIG. 8 a block diagram is disclosed of 8 input 8 output cascade coupled units. In a digital signal processing application such as a fourier transform, data does not loop and passes through a plurality of stages with each stage requiring the output of many stages prior. The present invention allows each unit to receive the evaluation results from up to eight prior stages and transfer results to up to eight subsequent stages. It can be appreciated that the depth and width of the cascaded units is not limited to the shown or discussed. Nor is the connection of high-speed serial links limited to a two dimensional array. The present invention further comprises an array of nxmxq units interconnected by 8 or more high-speed serial links.

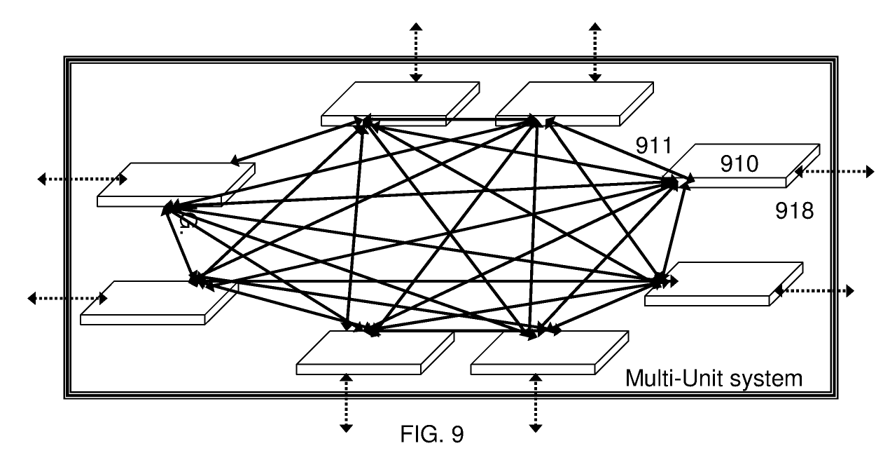

Referring now to FIG. 9 a block diagram is disclosed of eight units universally coupled. Each Unit has 8 links. In an 8 unit multi-unit system, 1 link 911 from each unit 910 is used to connect to a different unit. Each unit will have 1 spare link 918 after this connection. A second 8 unit multi-unit system may be attachably coupled to the first by marrying the spare links 91 8 to form a dual multi-unit system of 16 units.

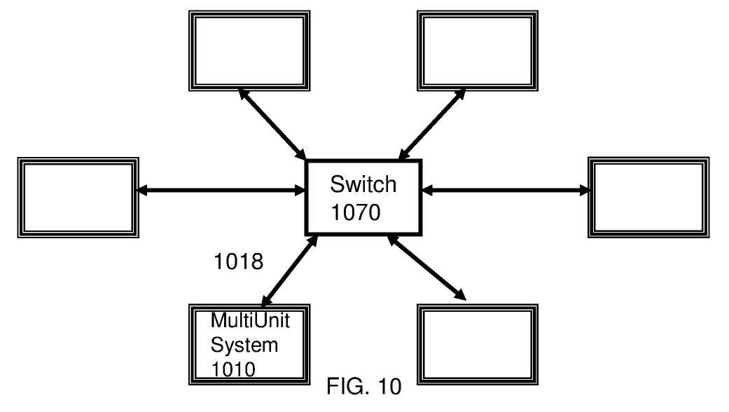

Referring now to FIG. 10 block diagram is disclosed of multi-units switchably coupled by a switch. The spare links 101 8 from a plurality of multi-unit systems 1010 can be connected to a switch 1070. Using compiler generated protocols the systems can send packets with the destination specified. The switch can use this information to direct the packets accordingly.

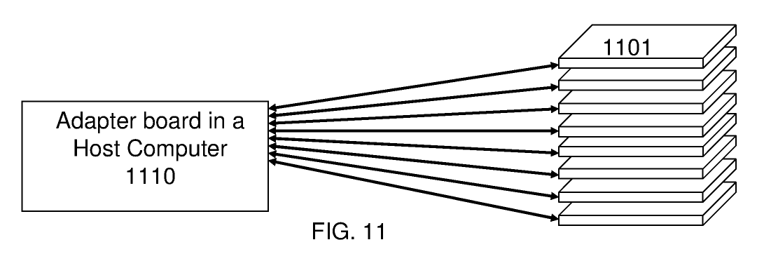

Referring now to FIG. 11 a block diagram is disclosed of units 1101 coupled to a host computer. By having an adapter board 1110 that has a plurality of high-speed serial link host connections, latency between the host computer and the units can be reduced.

An embodiment of the present invention comprises an apparatus for emulation and simulation of large electronic circuit designs, the apparatus presents a plurality of canvassing processors coupled to one or more high-speed serial links, the links coupled to certain evaluation processors wherein said evaluation processors may be coupled to other evaluation processors directly but some evaluation processors are scalably coupled only by means of the canvassing processor attached high-speed serial link.

A first evaluation unit control processor executes an instruction stream which includes an instruction to evaluate the transmission communication cluster by the method comprising the following steps: instructing the evaluation module plane comprising a plurality of evaluation processor to evaluate the cluster, sending the output data for this cluster to the canvassing processor, determining through a cluster instruction lookup table what to do with input data and which part of the data for this cluster is to be sent to another evaluation unit, and queuing that data to the serial link for transmission to a second evaluation unit.

The control processor in a second unit executes an instruction stream which includes an instruction to handle the receiver communication cluster, using a look up table which determines that the cluster is a receiver cluster from the first unit causing the control processor to check for data, wait for it, and then instructing the evaluation unit to evaluate the cluster, the control unit then popping the receiver data out of its fifo memory and transmitting it to the appropriate evaluation unit.

Critical Path Reducer

The present invention further comprises a method of selecting and reassigning nodes or nets within the critical path of a design to efficiently assign physical resources and communication bandwidth.

The method of critical path merging comprising the steps of
1. For each node v, computing the length of longest path from v. (Since the netlist is a DAG, the longest path exists and is finite.) Call this value the back rank of v.
2. Computing the length of longest path in the circuit. This times the intraboard delay is a lower bound on time to evaluate the domain. This value is the goal path length.
3. For each node v working from inputs to outputs, computing a rank as follows:
   computing the maximum rank of the node that drive its inputs, adding either the intraunit or the interunit delay pseudo-randomly, wherein, the rank of v is an estimate of how soon v can be evaluated and the compiler also knows the length of the longest path starting at v, whether v is on a path that is close to critical (The probability that the compiler chooses the intraboard delay is a function of how critical the most critical path containing v appears to be. If v is on long paths it chooses the intraboard delay with high probablity. If v is only on short paths, the compiler chooses the intraboard delay only with low probablity.),
   computing the minimum path length of v as the maximum driver rank of v plus the back rank of v times the intraunit delay,
   computing the maximum path length of v as the maximum driver rank of v plus the back rank of v times the interunit delay,
   if the minimum path length is greater than or equal to the goal length, using the intraunit delay, but if the maximum path length is at most the goal length, using the interunit delay, otherwise, using the interunit delay the closer the goal length is to the maximum path length.
4. For every pair of nodes u and v such that u drives v, merging u and v if ranks of u and v as computed in step 3 above differ by at least the interunit delay.

Reconfigurable Cabling.

The present invention further comprises the step of generating instructions to the reconfiguration of the high-speed serial link network according to the assignment of instructions to available evaluation units and the composition of canvassing instructions to transfer evaluation results to the evaluation units. A test program validates that the network complies with the desired high-speed serial link configuration.

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

### Conclusion

The present invention addresses the issue of scalability of emulation and simulation of electronic circuits in the design of more complex products in a timely manner. A great deal of parallelism is achieved by having an array of circuit evaluation processors attached to a plurality of canvassing processors which ensure the transfer of circuit signal values to those evaluation processors requiring the result of a previous evaluation. This is achieved by assigning evaluation instructions, reconfiguring a high speed serial link network, scheduling the evaluation instructions and inserting canvassing instructions to transfer the evaluation results.

The present invention provides means for electronics design engineers to verify, test, and analyze nanometer scaled integrated circuits and complex systems by executing instructions compiled from a hardware description language functional model of the hypothetical system prior to fabrication.

What is claimed is:

1. A system for verifying and emulating the operation of electronic circuit designs in anticipation of fabrication by simulation, comprising a first evaluation unit, a second evaluation unit, a network of high-speed serial links to transfer circuit signal value data from the first evaluation unit and receive and store circuit signal value data in the second evaluation unit, and a compiler.

2. A system for verifying and emulating electronic circuit designs comprising:
a first evaluation unit, the evaluation unit comprising:
a plurality of evaluation processors,
a plurality of canvassing processors,
one or more circuit signal value transfer circuits,
one or more circuit signal value reading circuits with associated storage device,
one or more circuit signal value storage units, and
one or more instruction storage units;
a second evaluation unit;
a high speed serial link to transfer deterministically scheduled circuit signal values sent by a transfer circuit in the first evaluation unit and read and stored in the second evaluation unit; and a compiler, tangibly encoded on a computer readable storage device as instructions controlling a computer system to perform the following method:
analyzing a circuit description for inherent circuit value data transfer activity among its elements,
translating the circuit description to evaluation processor instructions,
assigning the evaluation processor instructions to certain storage devices associated with certain evaluation processors to optimize circuit value data transfer,
composing canvassing processor instructions to ensure that results from certain evaluation processors are transferred to certain other evaluation processors according to the circuit description,
scheduling the execution of evaluation processor instructions and canvassing processor instructions to avoid deadlock, and
generating a cabling map for the interconnection of high-speed serial links to configure the available evaluation units to pass data by executing the canvassing instructions produced by the compiler.

3. An apparatus for emulation and simulation of large electronic circuit designs, the apparatus comprising a plurality of canvassing processors each coupled to eight or more reconfigurable high-speed serial links, the links each coupled to certain evaluation processors wherein said evaluation processors may be coupled to other evaluation processors directly but some evaluation processors are coupled only by means of the canvassing processor and the high-speed serial link.

4. An apparatus for emulation and simulation of large electronic circuit designs, the apparatus comprising a plurality of first processors each coupled to a plurality of reconfigurable high-speed serial links, the links each coupled to certain second processors which required the circuit signal evaluation results of the first processors to evaluate further circuit signals.

5. An apparatus for emulation and simulation of large electronic circuit designs, the apparatus comprising a plurality of first multi-unit systems coupled to a plurality of reconfigurable high-speed serial links, the links each coupled to a switch, the switch coupled to certain second processors which required the circuit signal evaluation results of the first processors to evaluate further circuit signals.

6. An apparatus for connecting a host computer to logic circuit evaluation units comprising an adapter board in a host computer, the adapter board comprising receivers and drivers of high-speed serial links, coupled to a plurality of high-speed serial links, each link coupled to an evaluation unit, whereby latency between the host computer and the units can be reduced.
